(19) United States
(12) Patent Application Publication
(10) Pub. No.: US 2009/0033755 A1
(43) Pub. Date: Feb. 5, 2009

(54) Image acquisition and processing engine for computer vision

(75) Inventors: Richard Mark Friedhoff, New York, NY (US); Steven Joseph Bushell, Cranston, RI (US); Kristin Jean Dana, Spring Lake, NJ (US); Bruce Allen Maxwell, Springfield, PA (US); Casey Arthur Smith, Ithaca, NY (US)

Correspondence Address: Davidson, Davidson & Kappel, LLC, 485 7th Avenue, 14th Floor, New York, NY, 10018, US

(73) Assignee: Tandent Vision Science, Inc., San Francisco, CA (US)

(21) Appl. No.: 11/889,000

(22) Filed: Aug. 3, 2007

(51) Int. Cl. H04N 9/64

(52) U.S. Cl. 348/222.1; 348/E09.01

(57) ABSTRACT

In an exemplary embodiment of the present invention, an image processor is provided. According to a feature of the present invention, the image processor comprises a CPU arranged and configured to receive an image input, the image input depicting a scene, the CPU being further arranged and configured to execute a routine to receive the image input and perform preselected spatio-spectral analysis of the image to create a version of the image input optimized for analysis of the scene.

### BACKGROUND OF THE INVENTION

Commercially available image capturing devices, such as, for example, digital cameras, typically record and store images in a series of pixels. Each pixel comprises digital values corresponding to a set of color bands, for example, most commonly, red, green and blue color components (RGB) of the picture element represented by the pixel. While the RGB representation of a scene recorded in an image is acceptable for viewing the image in an aesthetically pleasing color depiction, the red, green and blue bands, with typical commercially acceptable dynamic ranges, may not be optimal for computer processing of the recorded image for such applications as, for example, computer vision. Moreover, the illumination conditions at the time images are recorded may also not be optimal for a computer vision analysis of recorded images, for a task such as, for example, object recognition.

### SUMMARY OF THE INVENTION

The present invention provides a method and system for optimization of an image for enhanced analysis of material and illumination aspects of the image.

In a first exemplary embodiment of the present invention, an optical device is provided. According to a feature of the present invention, the optical device comprises a lens, an image sensor coupled to the lens, to generate images of a scene and a CPU coupled to the image sensor. The CPU is arranged and configured to execute a routine to receive the images and create a high dynamic range version of the images for spatio-spectral analysis. In an exemplary embodiment of the present invention, the optical device comprises a digital camera.

In a second exemplary embodiment of the present invention, an optical device is provided. According to a feature of the present invention, the optical device comprises a lens, an image sensor coupled to the lens, to generate images of a scene and a CPU coupled to the image sensor. The CPU is arranged and configured to execute a routine to receive the images, correct chromatic aberration in the images and create a high dynamic range version of the images for spatio-spectral analysis.

In a third exemplary embodiment of the present invention, an optical device is provided. According to a feature of the present invention, the optical device comprises a lens, a variable polarizer attached to the lens, an image sensor coupled to the lens, to generate images of a scene at preselected varying polarizer orientations and a CPU coupled to the image sensor. The CPU is arranged and configured to execute a routine to receive the images, and identify lit and shadow conditions as a function of polarizer orientation and to perform preselected preprocessing of the images to create a version of the images optimized for spatio-spectral analysis.

In a fourth exemplary embodiment of the present invention, an optical device is provided. According to a feature of the present invention, the optical device comprises a lens, an image sensor coupled to the lens, to generate images of a scene and a CPU coupled to the image sensor. The CPU is arranged and configured to execute a routine to receive the images and perform preselected preprocessing of the images to create a version of the images optimized for spatio-spectral analysis.

In a fifth exemplary embodiment of the present invention, an optical device is provided. According to a feature of the present invention, the optical device comprises a lens, an image sensor coupled to the lens, to generate images of a scene, the image sensor capturing the images in a preselected number of color bands, with the number and respective locations and widths of the color bands being selected to optimize the image for processing and a CPU coupled to the image sensor. The CPU is arranged and configured to execute a routine to receive the images and perform preselected preprocessing of the images to create a version of the images optimized for spatio-spectral analysis.

In a sixth exemplary embodiment of the present invention, an optical device is provided. According to a feature of the present invention, the optical device comprises a lens, an image sensor coupled to the lens, to generate images of a scene and a CPU coupled to the image sensor. The CPU is arranged and configured to execute a routine to receive the images and perform preselected preprocessing and spatio-spectral analysis of the images to create a version of the images optimized for analysis of the scene. According to a feature of the exemplary embodiment, the preselected preprocessing is selected from the group consisting of linearization, chromatic aberration correction, and high dynamic range image creation and the spatio-spectral analysis includes material and illumination information for the scene.

In a seventh exemplary embodiment of the present invention, an optical device is provided. According to a feature of the present invention, the optical device comprises a lens, an image sensor coupled to the lens, to generate images of a scene and a CPU coupled to the image sensor. The CPU is arranged and configured to execute a routine to receive the images and perform preselected spatio-spectral analysis of the images to create a version of the images optimized for analysis of the scene.

In an eighth exemplary embodiment of the present invention, an image processor is provided. According to a feature of the present invention, the image processor comprises a CPU arranged and configured to receive an image input, the image input depicting a scene, the CPU being further arranged and configured to execute a routine to receive the image input and perform preselected spatio-spectral analysis of the image to create a version of the image input optimized for analysis of the scene.

In a ninth exemplary embodiment of the present invention, an image processor is provided. According to a feature of the present invention, the image processor comprises a CPU arranged and configured to receive an image input, the image input depicting a scene, the CPU being further arranged and configured to execute a routine to receive the image input and perform preselected preprocessing and spatio-spectral analysis of the image to create a version of the image input optimized for analysis of the scene.

In accordance with yet further embodiments of the present invention, computer systems are provided, which include one or more computers configured (e.g., programmed) to perform the methods described above. In accordance with other embodiments of the present invention, computer readable media are provided which have stored thereon computer executable process steps operable to control a computer(s) to implement the embodiments described above. The methods described below can be performed by a digital computer, analog computer, optical sensor, state machine, sequencer or any device or apparatus that can be designed or programmed to carry out the steps of the methods of the present invention.

### BRIEF DESCRIPTION OF THE DRAWINGS

FIG. 1a is a simplified schematic representation of a lens/sensor arrangement for a digital camera.

FIG. 1b is a block diagram of a computer system arranged and configured to perform operations related to images.

FIG. 2 shows an n X m pixel array image file for an image stored in the memory of FIG. 1a or 1b.

FIG. 3 shows a schematic diagram of a camera pipeline according to a feature of the present invention.

FIG. 3a shows a block diagram for processing of an output from the camera pipeline of FIG. 3.

FIG. 4 is a schematic illustration of the data capture step of the routine shown in FIG. 3.

FIG. 5 illustrates the linearization step of the routine of FIG. 3.

FIG. 6 illustrates the Bayer processing step of the routine of FIG. 3.

FIG. 7a is a flow chart showing execution of the chromatic aberration correction step of FIG. 3.

FIG. 7b is a flow chart for selecting test blocks in an image, for execution of the routine of FIG. 7a, according to a feature of the present invention.

FIG. 7c shows a graph in RGB space of a pixel array, aligned in an image without chromatic aberration.

FIG. 7d shows a graph in RGB space of a pixel array, misaligned in an image with chromatic aberration.

FIG. 8 illustrates the HDR image creation step of the routine of FIG. 3.

FIG. 9 is a flow chart for identifying shadowed regions of an image depicted in a sequence of image files of the type depicted in FIG. 2, as a function of polarization characteristics, according to a feature of the present invention.

FIG. 10 shows a graph plotting pixel color values in an RGB space, the color values coming from selected points of a scene recorded in a sequence as a function of polarizer orientation, upon which the graph is superimposed, three in shadow and three in lit portions of the scene.

FIG. 11 shows a Sobel filter arrangement for generating a gradient representation of an image.

FIG. 12 illustrates an example of a convolution of image values with a Sobel filter in a gradient generation.

FIG. 13 is a flow chart for generating a gradient representation of an image that solely reflects material edges of objects, according to a feature of the present invention.

### DETAILED DESCRIPTION OF THE PREFERRED EMBODIMENTS

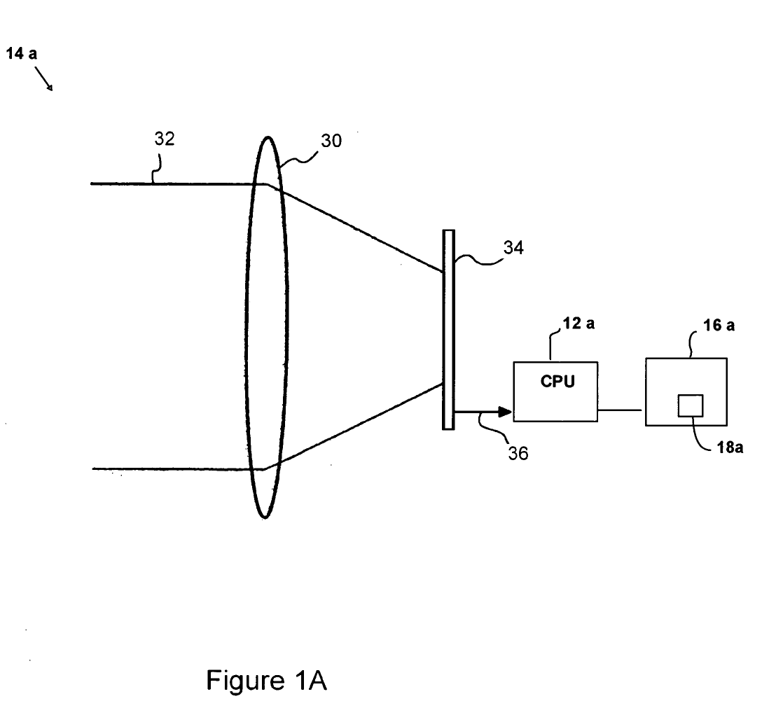

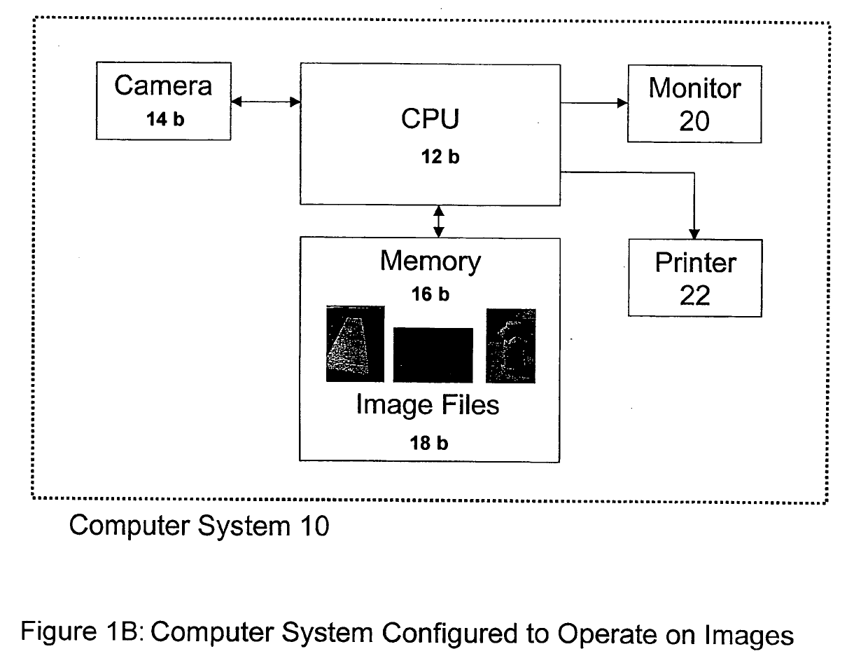

Referring now to the drawings, and initially to FIG. 1a, there is shown a simplified schematic representation of a lens/sensor arrangement for an optical device such as a camera 14a, which comprises a lens 30 that focuses a beam of light 32 onto a sensor 34. As known in the art, the sensor 34 responds to the beam of light 32 by generating an electrical signal at each of a plurality of surface sections corresponding to pixels, as will be described, each electrical signal being a function of the light intensity impinging on the respective section. The various electrical signals are output by the sensor 34 at line 36, for input to a device such as, for example, a preprocessor comprising a CPU 12a, which digitizes the electrical values, and stores in a memory 16a the digitized values as pixels of an image file 18. As noted above, in conventional commercial cameras, the digitized value for each pixel comprise or are processed to comprise, three numbers corresponding to red, green and blue components of the impinging light (RGB), corresponding to broad bands of light centered at, for example, 475 nm, 535 nm and 625 nm.

In FIG. 1b, there is shown a block diagram of a computer system 10 arranged and configured to perform operations related to images. A CPU 12b is coupled to a device such as, for example, a digital camera 14b via, for example, a USB port. The digital camera 14b operates to download images stored locally on the camera 14b, to the CPU 12b. The CPU 12b stores the downloaded images in a memory 16b as image files 18b. The image files 18b can be accessed by the CPU 12b for display on a monitor 20, or for print out on a printer 22.

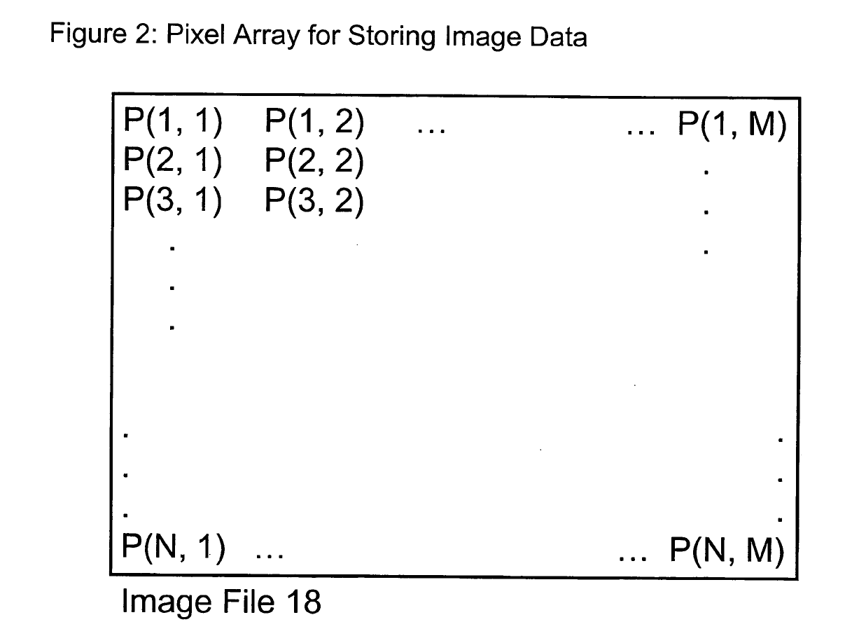

As shown in FIG. 2, each image file 18 comprises an n X m pixel array. Each pixel, p, is a picture element corresponding to a discrete portion of the overall image. All of the pixels together define the image represented by the image file 18. Each pixel comprises digital values corresponding to a set of color bands, for example, red, green and blue color components (RGB) of the picture element. The present invention is applicable to any multi-band image, where each band corresponds to a piece of the electromagnetic spectrum. The pixel array includes n rows of m columns each, starting with the pixel p (1,1) and ending with the pixel p(n, m). When displaying or printing an image, the CPU 12 retrieves the corresponding image file 18 from the memory 16, and operates the monitor 20 or printer 22, as the case may be, as a function of the digital values of the pixels in the image file 18, as is generally known.

In the this detailed description, each of the reference numerals 12, 14, 16 and 18 refer to the corresponding elements of either FIGS. 1a or 1b. In an image operation, the CPU 12 operates to analyze the RGB values of the pixels of a stored image file 18 to achieve various objectives, such as, for example, to process the image with respect to material and illumination aspects of the image. According to a feature of the present invention, the CPU 12a operates to perform certain preprocessing operations at the camera 14a, to optimize the image and store the optimized image for further processing in respect of material and illumination aspects of the image. The CPU 12b of the computer system 10 of FIG. 1b is arranged and configured to perform the same preprocessing as the CPU 12a, in the event the camera 14b does not have such preprocessing functionality.

A fundamental observation underlying a basic discovery of the present invention, is that an image comprises two components, material and illumination. All changes in an image are caused by one or the other of these components. A method for detecting of one of these components, for example, illumination, provides a mechanism for distinguishing material or object geometry, such as object edges, from illumination and shadow boundaries. What is visible to the human eye upon display of a stored image file 18 by the CPU 12, is the pixel color values caused by the interaction between specular and body reflection properties of material objects in, for example, a scene photographed by the digital camera 14 and illumination flux present at the time the photograph was taken. The illumination flux comprises an ambient illuminant and an incident illuminant. The incident illuminant is light that causes a shadow and is found outside a shadow perimeter. The ambient illuminant is light present on both the bright and dark sides of a shadow, but is more perceptible within the dark region.

The spectra for the incident illuminant and the ambient illuminant can be different from one another. A spectral shift caused by a shadow, i.e., a decrease of the intensity of the incident illuminant, will be substantially invariant over different materials present in a scene depicted in an image. Thus, a spatio-spectral analysis of the image can be implemented to identify spectral differences across a certain spacial extent of the image for identification of illumination flux. For example, a spectral ratio is a ratio based upon a difference in color or intensities between two areas of a scene depicted in an image, which may be caused by different materials, an illumination change or both. Inasmuch as an illumination boundary is caused by the interplay between the incident illuminant and the ambient illuminant, spectral ratios throughout the image that are associated with illumination change, should be consistently and approximately equal, regardless of the color of the bright side or the material object characteristics of the boundary. A characteristic spectral ratio is defined as a spectral ratio associated with an illumination boundary of a scene depicted in an image file. A characteristic spectral ratio can therefore be determined by sampling pixels from either side of a boundary known to be an illumination boundary.

A spectral ratio can be defined in a number of ways such as, for example, B/D, B/(B−D) and D/(B−D), where B is the color on the bright side of the shift and D is the color on the dark side. As a general algorithm for implementing a spatio-spectral analysis, pixel values of an image file 18, from both sides of a boundary, are sampled at, for example, three intensities or color bands, in long, medium and short wave lengths such as red, green and blue. A spectral ratio is calculated from the sampled color values. If the spectral ratio associated with the boundary is approximately equal to the characteristic spectral ratio determined for the scene, the boundary would be classified as an illumination boundary. In this manner, illumination boundaries of a scene depicted in an image file 18 can be identified.

Moreover, a pixel analysis of spatio-spectral characteristics of a scene can be implemented to identify regions of an image that correspond to a single material depicted in a scene recorded in the image file 18. A token is a connected region of an image wherein the pixels of the region are related to one another in a manner relevant to identification of image features and characteristics such as identification of materials and illumination. The pixels of a token can be related in terms of either homogeneous factors, such as, for example, close correlation of color among the pixels, or inhomogeneous factors, such as, for example, differing color values related geometrically in a color space such as RGB space, commonly referred to as a texture. Spatio-spectral information relevant to contiguous pixels of an image depicted in an image file 18 can be used to identify token regions. The spatio-spectral information includes spectral relationships among contiguous pixels, in terms of color bands, for example the RGB values of the pixels, and the spatial extent of the pixel spectral characteristics relevant to a single material.

However, as noted above, a typical commercially available digital camera records an RGB representation of a scene with commercially acceptable dynamic ranges and other characteristics that are not necessarily optimal for computer processing of the recorded image in respect of spatio-spectral information relevant to pixel values for identification of material and illumination aspects of the image. Accordingly, the present invention provides exemplary embodiments for capturing image data and preprocessing of the image data to optimize the pixel representations of a scene for further improved spatio-spectral processing.

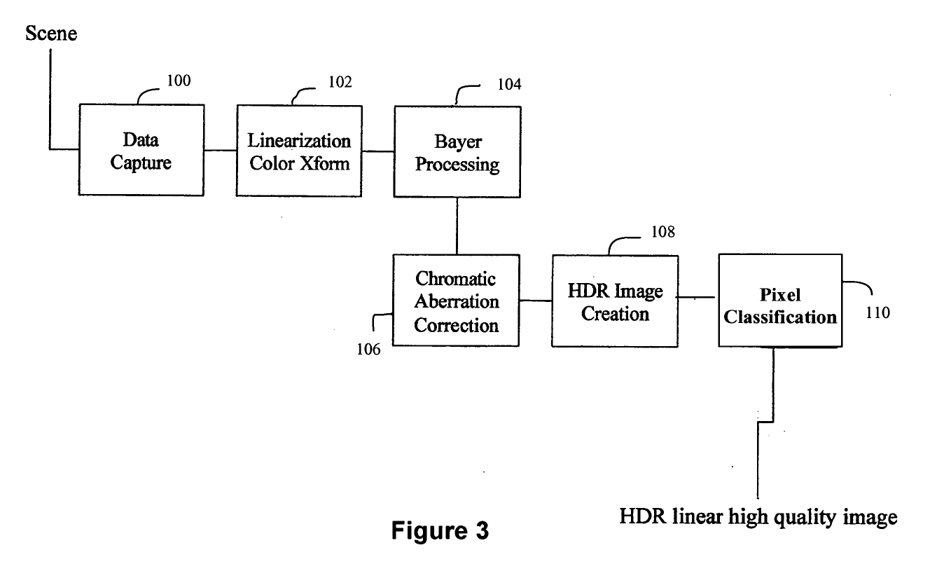

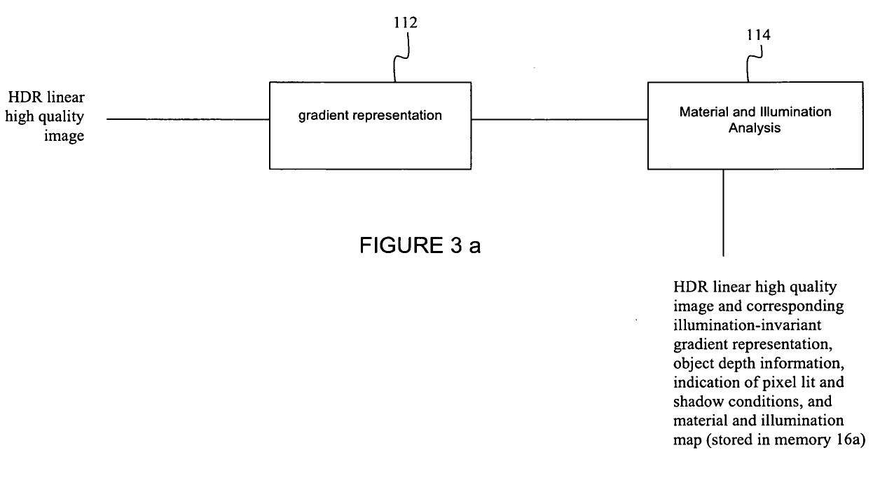

FIG. 3 shows a schematic diagram of a camera pipeline according to a feature of the present invention. In a first data capture step 100, the camera 14 is implemented to record a scene with data capture functionality that includes, for example, multiple exposures, polarization, stereo image information for depth determinations, and a selected N band representation for the image wherein N equals a number of color bands, with the number and respective locations and widths of the N color bands being selected to optimize the image for spatio-spectral processing. In step 102, the CPU 12 operates to execute a linearization of the captured data, to transform each color value to a calibrated value. In step 104, a Bayer process is executed to generate fully populated values at each pixel location of an image file 18. In step 106, the CPU 12 corrects any chromatic aberration that may occur during the data capture step (step 100). Thereafter, the CPU 12 performs a high dynamic range (HDR) image creation (step 108). In step 110, the CPU 12 operates to classify each pixel as either lit or in shadow, and outputs an HDR linear high quality image, stored as an image file 18.

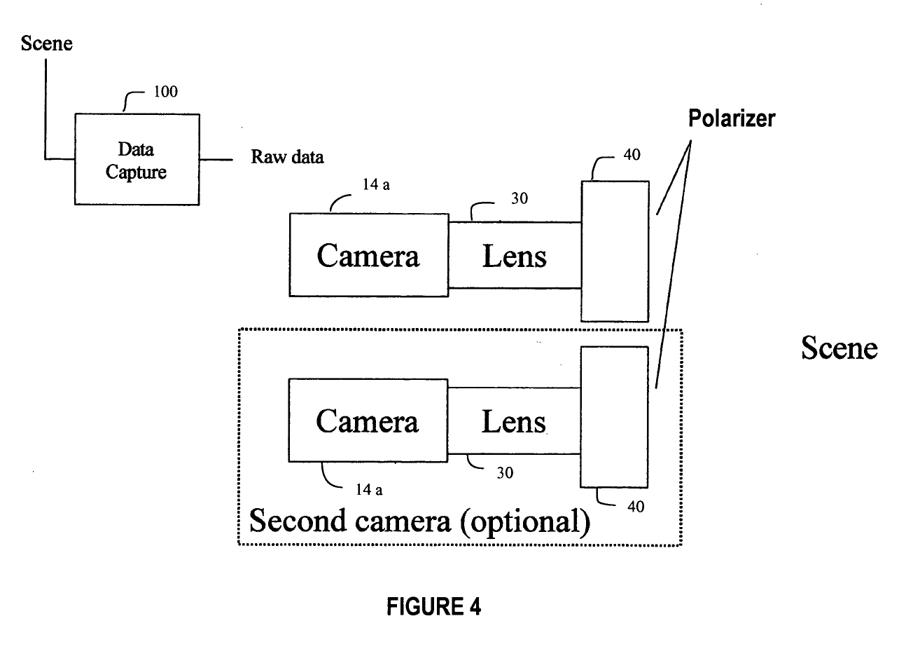

FIG. 4 is a schematic illustration of the data capture step 100 of the routine of FIG. 3. As shown in FIG. 4, in an exemplary embodiment of the present invention, a camera arrangement comprises two parallel cameras 14a, each including a lens 30 and a polarizer 40. The cameras 14a are focused on a scene to be recorded. During the data capture step 100, the cameras 14a are operated to record a sequence of stereo pairs of images (one image per pair by each camera 14a) of the scene, for a sequence of pairs of image files 18, each one of the sequence of image files 18a (see FIG. 1a) corresponding to the scene photographed in a different polarization direction of the respective polarizer 40.

In accordance with a discovery relevant to the present invention, another physical property of illumination flux comprises polarization characteristics of the incident illuminant and the ambient illuminant. The polarization characteristics can be used to identify shadowed areas of a subject image. Direct sunlight is typically not polarized but becomes partially polarized upon reflection from a material surface. Pursuant to a feature of the present invention, an analysis is made regarding differences in polarization in light reflected from various regions of a recorded image, due to variations of the interplay of the incident illuminant and the ambient illuminant, to determine shadowed and unshadowed regions of the image. The variations of the interplay, according to a feature of the present invention, comprise differences between the polarization of the reflected incident illuminant and the polarization of the reflected ambient illuminant.

Pursuant to a feature of the present invention, each polarizer 40 comprises a Quantaray circular polarizer. However, a linear polarizer can be used in place of a circular polarizer. During the data capture step 100, each polarizer 40 is rotated through preselected angular orientations and a pair of image files 18 (one per camera 14a) is recorded for each angular orientation of the polarizer. For example, each polarizer 40 can be oriented from 0° to 180° in increments of 10° with a pair of image files 18 corresponding to each 10° incremental orientation. In general, overall image intensities are modulated as a function of polarizer direction. The modulation varies spatially and spectrally. As will be described in detail, in step 110, the CPU 12a is operated such that for each pixel location (p (1,1) to p(n, m) (see FIG. 2)) of a sequence of pairs of image files 18, the respective pixels are classified as either lit or in shadow, as a function of the set of color values for a respective pixel location, throughout a sequence of image files 18 corresponding to a scene, as recorded at the various angular orientations of the polarizer 40.

In accordance with yet another feature of the present invention, the pairs of image files 18, one per camera 14a, for a scene, provide a stereo representation of the scene for image depth analysis. A disparity map generated as a function of information obtained from a left/right pair of image files 18 for a scene, provides depth information for the scene depicted in the pair of image files 18. Disparity between corresponding pixel locations of the left/right pair refers to the relative horizontal displacement of objects in the image. For example, if there were an object in the left image at location (X1, Y), and the same object in the right image at location (X2, Y), then the relative displacement or disparity is the absolute value of (X2-X1). In a known technique, disparity between two pixels, referred to as the correspondence problem, includes the selection of a pixel, and examining a grid of pixels around the selected pixel. For example, a 20X1 pixel grid is compared to the corresponding grid of the other image of the image pair, with the closest match determining an X difference value for the pixel location.

A disparity measure is inversely proportional to the distance of an object from the imaging plane. Nearby objects have a large disparity, while far away or distant objects have a small disparity. The relative depth of an object from the imaging plane, Distance=c/disparity, where c is a constant whose value can be determined for a calibrated pair of cameras 14a. Thus, a spatio-spectral analysis of pixels on opposite sides of a boundary can be performed more accurately when it can be determined whether the two pixels depict objects that are in fact adjacent, and are not separated spatially from each other, relative to the imaging plane. In an alternative exemplary embodiment of the present invention, a single camera 14a is provided, and depth information is obtained by a parallel and aligned range sensor, such as a laser sensor, to capture depth information directly.

According to a feature of the present invention, the camera 14a may comprise a hyperspectral digital camera such as Surface Optics model SOC700-V camera (see www.surfaceoptics.com). The hyperspectral camera 14a records an image in 120 color bands spaced from approximately 419 nm to approximately 925 nm. The 120 recorded bands can be used to simulate any subset of the 120 bands, for example, 3, 4 or 5 bands of the 120 total bands can be examined. Different bandwidths can be synthesized by taking weighted averages of several bands, for example (band 30*0.2+band 31*0.6+band 32*0.2).

A spectral mimic is an occurrence of the same measured color values among different materials. The reduction of a number of occurrences of spectral mimics improves the accuracy of analysis to thereby optimize a computer operation to separate illumination and material components of an image. The RGB color bands of typical commercially available digital cameras do not necessarily provide a representation of an image with minimal occurrences of spectral mimics. Pursuant to a feature of the present invention, determination of an optimal set of color bands is performed via an experimental procedure wherein a montage of images of samples of material spectra is used to provide a range of illumination for each sample material within the montage, from incident to ambient. A series of observations of a quantity of spectral mimics is made in respect of a number of sets of recorded images generated from the montage, each set of recorded images comprising selected numbers of color bands from the recorded 120 bands, and being evaluated in respect of different locations of bands, different numbers of bands and different widths of the bands. In this manner, a minimum number of spectral mimics can be correlated to optimal band location, number and width, and further correlated to different environments and illumination conditions.

After completion of such experimentation, image files 18 can be recorded in either RGB color bands and/or the selected number N of bands found to minimize spectral mimics. Thus, in the data capture step 100, image data is stored in a manner that maximizes the ability of the CPU 12 to accurately process spatio-spectral information.

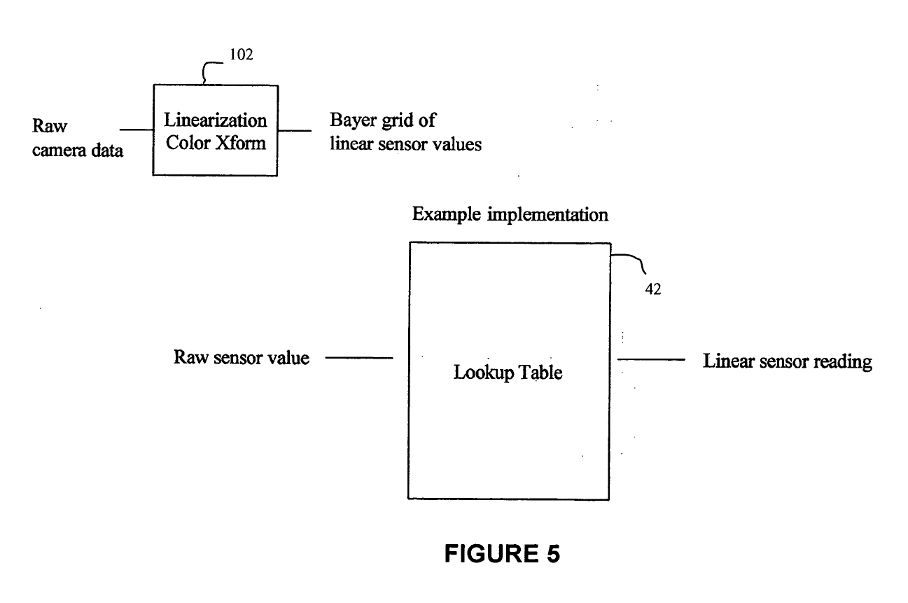

Details of step 102 are shown in FIG. 5. Raw sensor values from the cameras 14a, are input by the CPU 12 to a lookup table 42 (for example, stored in the memory 16a) that contains for each possible sensor value input, a corresponding corrected sensor response. The corrected values in the lookup table can be determined by imaging a calibration target with known reflectances. The results are placed in the lookup table such that the corrected sensor values correspond to linear responses to the known reflectance target, as is generally known in the art. For example the Canon 20D Digital camera implements a linear response recording of an image. The corrected values are then stored in the respective image files 18.

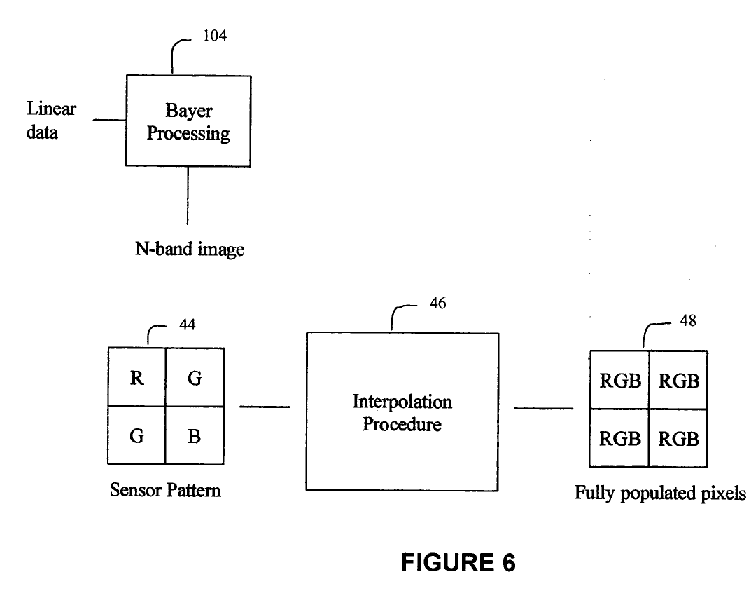

Details of step 104 are shown in FIG. 6. Typically, the sensor 34 (see FIG. 1a) captures color information at each surface section (corresponding to a pixel location in an image file 18) in one color band. Thus, in an RGB representation of color, a single raw image pixel will store one of an R, G or B value, as shown in block 44 of FIG. 6. The raw image values are input to an interpolation procedure 46, that can comprise a software module executed by the CPU 12, to fully populate each pixel location of the image files 18, with all of the values for a full color, in our example, RGB values.

As implemented in commercially available digital cameras, the raw image can include sensor values of pure red, green and blue values (RGB), in a common Bayer pattern sensor array such as:

G(1, 1) B(2, 1) G(3, 1)

R(1, 2) G(2, 2) R(3, 2)

G(1, 3) B(2, 3) G(3, 3)

Wherein the numbers in parenthesis represent the column and row position of the particular color sensor in the array. These sensor positions can be expressed as RGB values:

RGB(X, G(1, 1), X) RGB(X, X, B(2, 1)) RGB(X, G(3, 1), X)

RGB(R(1, 2), X, X) RGB(X, G(2, 2), X) RGB(R(3, 2), X, X)

RGB(X, G(1, 3), X) RGB(X, X, B(2, 3)) RGB(X, G(3, 3), X)

Where X, in each instance, represents a value yet to be determined.
A raw conversion constructs a color value for each X value of a sensor location. A known, simplistic raw conversion calculates average values of adjacent sensor locations to reconstitute missing pixel values. For example, for the center sensor, x, y(2, 2), RGB((X, G(2, 2), X), the X values are computed as follows to generate a full pixel RGB value: RGB((R(1, 2)+R(3, 2))/2, G(2, 2), (B(2, 1)+B(2, 3))/2). The R value for X of the pixel is the average of the R's of sensors of adjacent columns to the G(2, 2) sensor, and the B value for X is the average of the adjacent rows of the G(2, 2) sensor.

Thus, the interpolation procedure 46 outputs a data block 48, wherein each pixel location of the respective image files 18 is now represented by RGB values. The routine of FIG. 6 can be executed in respect of the N band images as well, in a similar manner, to populate each pixel location with values for each selected band determined through experimentation. In step 106, the CPU 12a operates to correct chromatic aberration that may exist in the images recorded in the image files 18.

Chromatic aberration is a phenomena that can occur during recording of an image. When an image is properly recorded by a sensor, each of the color channels, in our example, Red, Green and Blue channels, align precisely with one another in a composite image, with the image exhibiting sharp edges at an object boundary. When the image is recorded with chromatic aberration, the Red, Green and Blue channels are recorded at different degrees of magnification. The differing degrees of magnification result in the composite image exhibiting blurry edges and chromatic fringes.

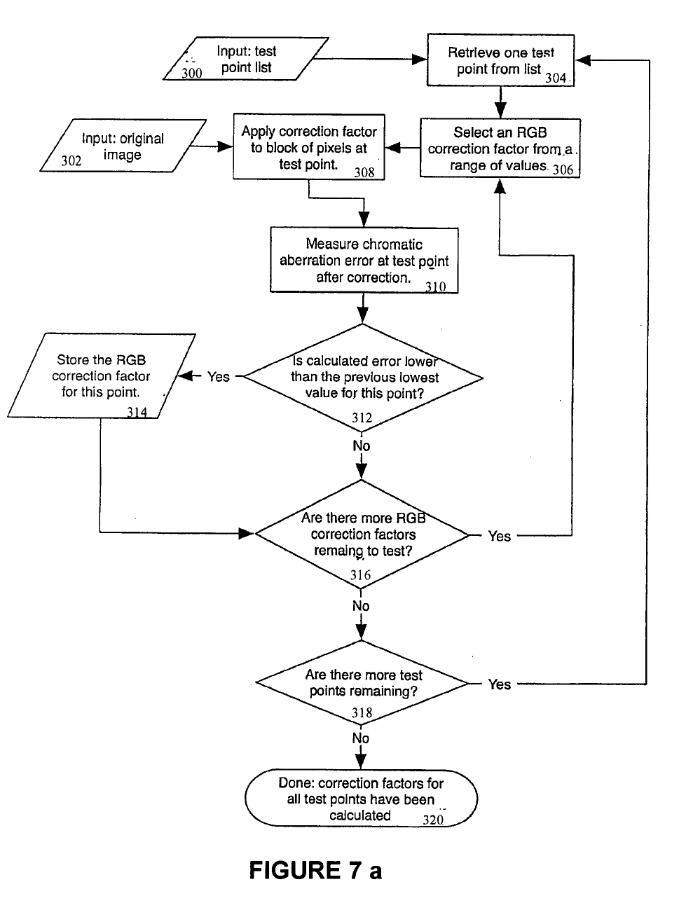

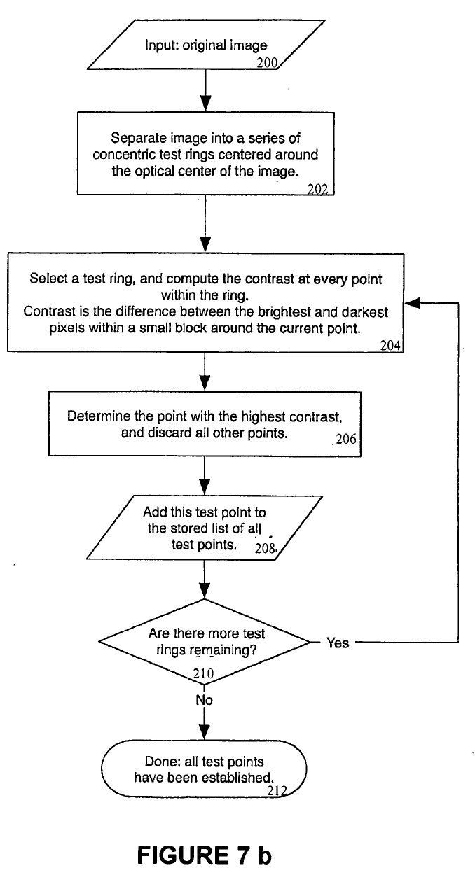

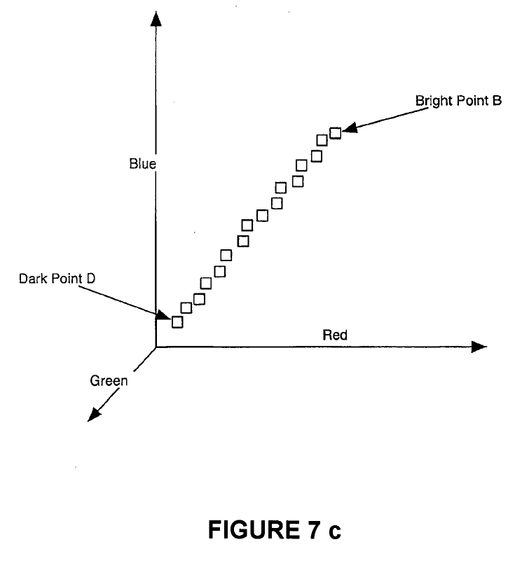

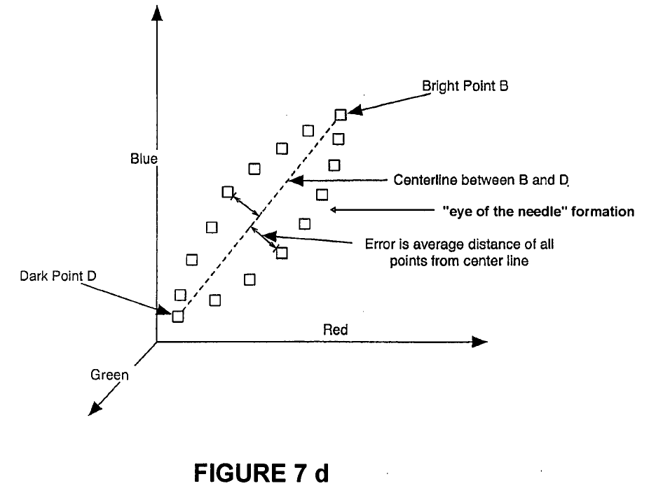

According to a feature of the present invention, a useful characterization of the appearance of materials under two illuminants is derived from a bi-illuminant dichromatic reflection model (BIDR) of the image. The BIDR model indicates the appearance of a material surface that interacts with an illumination flux comprising an incident illuminant and an ambient illuminant having different spectra. For example, the BIDR model predicts that the color of a specific material surface is different in shadow than the color of that same surface when partially or fully lit, due to the differing spectra of the incident illuminant and the ambient illuminant. The BIDR model also predicts that the appearance of a single-color surface under all combinations of the two illuminants (from fully lit to full shadow) is represented by a line in a linear color space, such as, for example, an RGB color space, that is unique for the specific material and the illuminant combination interacting with the material (see FIG. 7c).

However, when an image is recorded with an optical system that causes a chromatic aberration, a transition from bright to dark results in an array of pixels in RGB space that form an “eye of the needle” formation, as shown in FIG. 7d. According to a feature of the present invention, an automatic correction of chromatic aberration is achieved through an analysis of differences between a correct BIDR model linear representation of a dark to bright transition in an image and the “eye of the needle” formation caused by chromatic aberration. FIG. 7a is a flow chart for automatically determining a correction factor for chromatic aberration utilizing test blocks identified in the routine of FIG. 7b, according to a feature of the present invention.

FIG. 7b is a flow chart for selecting the test blocks. In step 200, an image file 18 is accessed by the CPU 12a, as an input to the routine. In step 202, the CPU 12 divides the image into concentric circles. In step 204, the CPU 12a selects one of the concentric circles and computes the contrast between pixels within the selected circle. The step is carried out by sampling a series of blocks, each comprising an N×N block of pixels within the selected circle, and for each sample block, determining the difference between the brightest and darkest pixels of the block. N can be set at 4 pixels, to provide a 4×4 pixel mask (for a total of 16 pixels) within the current circle. The CPU 12a operates to traverse the entire area of the current concentric circle with the sample block as a mask.

In step 206, the CPU 12a determines the block (N×N block) of the current concentric circle with the highest contrast between bright and dark pixels, and in step 208, lists that test block as the test block for the current concentric circle. In determining the block with the highest contrast, the CPU 12a can determine whether the block contains pixels that are clipped at the bright end, and disregard that block or individual pixels of that block, if such a condition is ascertained. When a block having clipped bright pixels is disregarded, the CPU 12 selects a block having the next highest contrast between bright and dark pixels. In step 210, the CPU 12a enters a decision block to determine if there are additional concentric circles for computation of a test block. If yes, the CPU 12a returns to step 204, to select one of the remaining circles and repeats steps 204-210. If no, the CPU 12a outputs the list of test blocks (step 212).

According to a feature of the present invention, the routine of FIG. 7a utilizes the test blocks listed by the CPU 12a during execution of the routine of the flow chart of FIG. 7b, which is an input to the routine (step 300). The image file 18 for which test blocks have been selected, is also input to the CPU 12a (step 302). In step 304 the CPU 12a retrieves one of the test blocks from the test block list and in step 306, the CPU 12a selects a correction factor, for example, an RGB correction factor, from a range of correction factors.

According to a feature of the present invention, the range of correction factors focuses upon a range of relative magnification values for the various bands or color channels of the image, in our example, RGB values, to determine a set of relative values that will compensate for the chromatic aberration caused by an optical system. In a preferred embodiment of the present invention, the green channel is set at 1, and the red and blue channels are incrementally varied through selected values. A series of increments can begin in the red channel, with red set for a range of 1+M to 1−M, for example, M=0.002. The range can include S equal step values between 1+M and 1−M, for example, S=5. A similar series of steps can be set for the blue channel. The steps can be tested sequentially, varying the correction factor by the steps for the range of each of the red and blue channels.

In step 308, the CPU 12a corrects the pixels at the test block of the image by altering the relative magnification between the RGB channels, using the first correction factor selected from the range described above. In step 310, the chromatic aberration of the image is measured at the current test block of the image, after the correction. FIG. 7d illustrates measurement of chromatic aberration in an example of an image with chromatic aberration. As discussed above, the BIDR model predicts a linear relationship among pixels between a dark pixel and a bright pixel of a material. As also discussed, an “eye of the needle” formation, among the pixels in RGB space, results when chromatic aberration is present in the image. Thus, according to a feature of the present invention, the chromatic aberration at a test block of the image is measured by plotting the color channel bands of the image, in our example, RGB values of the current test block of the image, in an RGB space and setting a reference line comprising a centerline between, in our example, the dark and bright pixels of the plot. Other methods for finding an appropriate centerline can include the use of a primary eigenvector of the covariance matrix of the test block (a PVA analysis). Thereafter, a measure of error due to chromatic aberration is defined as the average distance of all intermediate pixel locations from the centerline, as shown in FIG. 7c.

In a decision block (step 312), the CPU 12a determines whether the error calculated in step 310 is greater that a previous error for that test block. The previous error value can be initialized at an arbitrary high value before the initial correction of the current test block. If the error value is less than the previous error value, then the CPU 12a stores the current RGB correction factor as the correction factor for the test block (step 314), and proceeds to step 316. If the error value is greater than the previous error value, the CPU 12a proceeds directly to step 316.

In step 316, the CPU 12a determines whether there are more RGB correction factors from the range set up in step 306. If all of the values for red and blue range have been tested, the range can be reset around the correction factor having the lowest error value, within a range defined by reduced value of M, for example, M_{new}=M_{old}/S. This reduction of incremental step values around a best factor of a previous calculation can be repeated a number of times, for example 3 times, to refine the determination of a best correction factor. The method described regarding steps 306-316 comprises an iterative exhaustive search method. Any number of standard ID search algorithms can be implemented to search for a lowest error value. Such known search techniques include, for example, exhaustive search, univariate search, and simulated annealing search methods described in the literature. For example, the univariate search technique is described in Hooke & Jeeves, “Direct Search Solution of Numerical and Statistical Problems,” Journal of the ACM, Vol. 8, pp 212-229, April, 1961. A paper describing simulated annealing is Kirkpatrick, Gelatt, and Vecchi, “Optimization by Simulated Annealing,” Science 220 (1983) 671-680. Various other search techniques are described in Reeves, ed., Modern Heuristic Techniques for Combinatorial Problems, Wiley (1993).

If all correction factors have not been tested, the CPU 12a returns to step 306 to select another RGB correction factor and repeats steps 308-316. If all of the correction factors have been tested, the CPU proceeds to step 318.

In step 318, the CPU 12a determines whether there are any test blocks remaining for determination of an RGB correction factor. If yes, the CPU 12a returns to step 304 to select another test block, and repeats steps 306-318. If no, the CPU 12a proceeds to step 320 to output a correction factor for each test block. The CPU 12 can then proceed to correct chromatic aberration, using each correction factor in a respective concentric ring of the image.

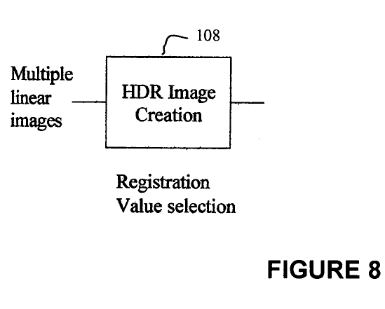

In step 108 (see FIG. 3), the CPU 12a operates to create a high dynamic range version of the images processed in the previous steps of the camera pipeline of FIG. 3. FIG. 8 illustrates the HDR image creation step of the routine of FIG. 3. According to a feature of the present invention, during the data capture step 100, the cameras 14a are further operated to take a preselected number images of the scene, for example, three images, each recorded at a different aperture/exposure setting, to provide relatively dark, middle, bright image versions of the scene. The sequence of varying exposure images can be nestled within the sequence of images corresponding to the rotation through the preselected angular orientations of the polarizers 40, such that each angular orientation of each polarizer 40 has relatively dark, middle, bright image versions of the scene.

For each dark/middle pair of images, the CPU 12a identifies all pixels within a middle range of color intensity values of the pixels, for example, 10% to 90% of the full range for the images, and mask off the remaining pixels (mask M1), to eliminate very dark and very bright pixels. A similar routine is executed by the CPU 12a in respect of each middle/bright pair of images to determine a second mask, M2.

Using all the unmasked pixels (that is the 10^{th} to 90^{th} percentiles), the CPU 12a calculates the exposure change for each of the dark and bright images relative to the middle image to calculate a range. For example, for each color band, the CPU 12a calculates a dark to middle ratio and a middle to bright ratio. Each ratio is based upon the intensity difference for the color band between pixels of the dark and middle exposures, and the middle and bright exposures, respectively. For each pixel, over each color band, for example RGB, the CPU 12a operates to select the color band value from among the dark, middle and bright versions of each pixel location that is most exposed (brightest), and least saturated (less than a threshold percentage of the range (for example, 90%)). The CPU 12a then uses the selected color value to calculate the value for the respective color band with respect to the middle image. Thus, if the selected value is in the middle image, the value remains the same. If the selected color value is in the dark image, the value is multiplied by the dark to middle ratio, and the result replaces the corresponding value in the middle image. If the selected color value is in the bright image, the value is multiplied by the middle to bright ratio, and the result replaces the corresponding value in the middle image. The middle image is then output as an HDR image for storage as an image file 18.

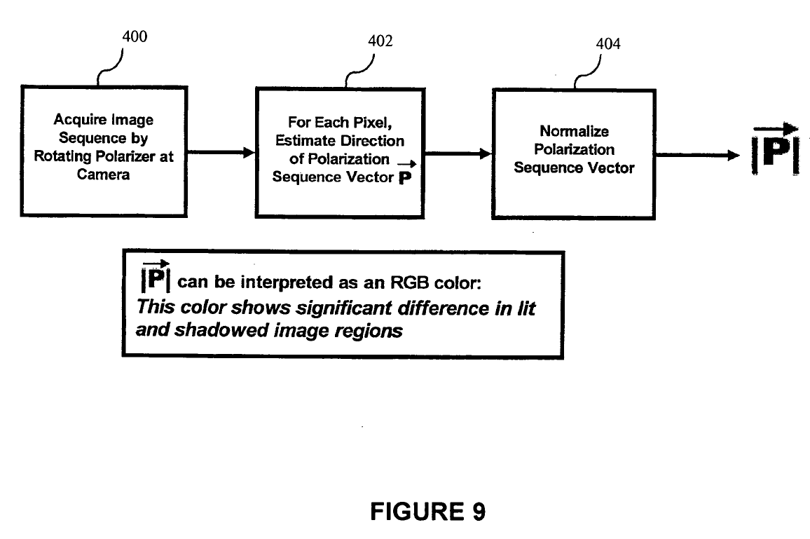

In the pixel classification step 110 (see FIG. 3), the CPU 12 is operated such that for each pixel location (p (1,1) to p(n, m) (see FIG. 2)) of each pair of image files 18, the set of color values for a respective pixel location, throughout the sequence of image files 18 corresponding to a scene, as recorded at the various angular orientations of the polarizer (data capture step 100, FIG. 3, step 400 of FIG. 9), is organized as a vector in a color space, for example RGB space. RGB space corresponds to a three dimensional graph wherein the three axes define the red, green and blue values of a pixel. The vector in RGB space is a polarization sequence vector P\vec{} with the intensity of a pixel location traveling along the direction of P\vec{}, as a function of the intensity variations for the respective pixel location, throughout the sequence of image files 18 corresponding to the scene. The polarizer has the effect of modulating the intensity of polarized light with a sinusoidal multiplicative factor, thus the intensity value will travel in both positive and negative directions along P\vec{}. Moreover, the direction of the vector P\vec{} is a function of the illumination characteristics of the pixel location, that is, lit or shadow. Thus, the direction of a polarization sequence vector P\vec{} can be used to determine whether the corresponding pixel location is in a lit portion of the scene, or a portion of the scene in shadow.

Estimation of the direction of P\vec{} (step 402, FIG. 9), is a three dimensional line fitting problem. An estimation of a vector direction for a set of pixel color values corresponding to a pixel location in a sequence of image files 18 of a scene at different angular orientations of the polarizer, can be achieved with standard mathematical tools such as singular value decomposition and Random Sample Consensus (RANSAC). the CPU 12 operates, with respect to each polarization sequence vector P\vec{} to generate a normalized value of the vector |P\vec{}|, (step 404). The normalized value |P\vec{}| is interpreted as an RGB value that reflects a significant difference between pixel locations in lit and shadowed areas of a scene. The CPU 12 further operates to classify each pixel location as in shadow or lit, as a function of the normalized values for the respective pixel locations.

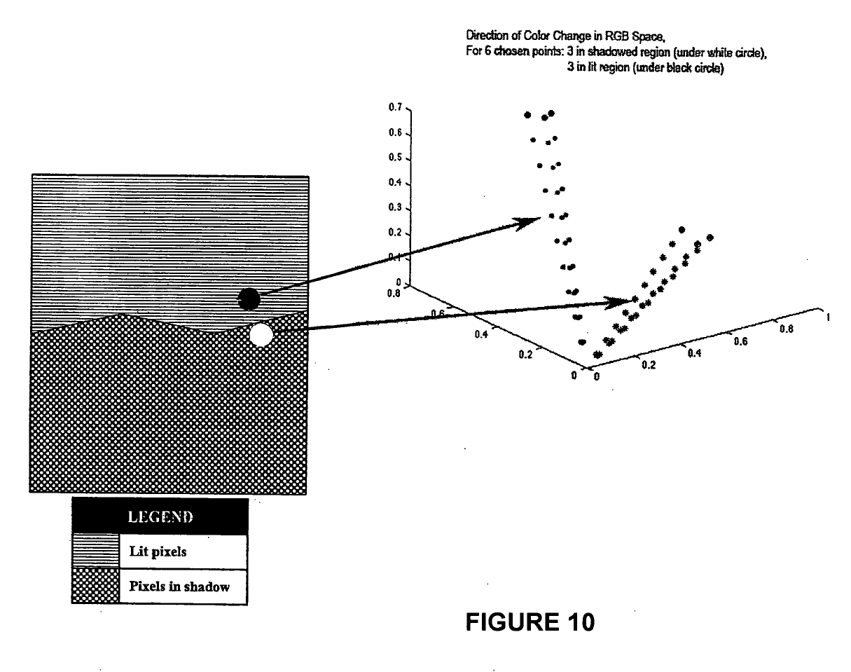

FIG. 10 shows a graph plotting pixel color values in an RGB space, the color values coming from selected points of a scene upon which the graph is superimposed, three in shadow and three in lit portions of the scene. The pixel color values of each selected point form a polarization sequence vector as a function of a sequence of image files 18 containing the respective point, at different angular orientations of the polarizer, as described above. The points illustrated in the graph of FIG. 4 where selected manually. A direction in the RGB color space for each selected point was estimated using one of the mathematical tools described above. The color of each point changes as a function of the angular orientation of the polarizer, but the direction of change is different for lit points as opposed to points in shadow. In the graph of FIG. 4, the polarization sequence vectors corresponding to lit points are indicated by an arrow from a lit portion of the scene, while each of the points in shadow are indicated by an arrow from a shadowed portion of the scene.

Data capture of images and preprocessing of the captured images, as described above, optimizes images for improved spatio-spectral analysis of image pixels by providing a high dynamic range, linear, high quality image, with lit and shadow pixel, and object depth information available for downstream spatio-spectral processing.

FIG. 3a shows further processing steps for the high dynamic range, linear, high quality image output by the data capture and preprocessing of steps 100-110. As shown in FIG. 3a, a gradient representation of the input high dynamic range, linear, high quality image is generated by the CPU 12a (step 112) and, further, the CPU 12a performs a spatio-spectral analysis on the image (step 114).

Gradients are often utilized to provide a more suitable representation of an image for purposes of computer processing. A gradient is a measure of the magnitude and direction of color and/or color intensity change within an image, as for example across edges caused by features of objects depicted in the image. A set of gradients corresponding to an object describes the appearance of the object, and therefore features generated from gradients can be utilized in a computer processing of an image to concisely represent significant and identifying attributes of the object.

In one known technique for generating a gradient representation of an image, a Sobel filter is used in a convolution of pixel values of an image file 18. Sobel filters can comprise pixel arrays of, for example, 3×3, 5×5 or 7×7. Other known techniques can be used to generate gradient representations, see, for example, Michael D. Heath, Sudeep Sarkar, Thomas Sanocki, Kevin W. Bowyer, “Robust Visual Method for Assessing the Relative Performance of Edge-Detection Algorithms,” IEEE Transactions on Pattern Analysis and Machine Intelligence, vol. 19, no. 12, pp. 1338-1359, December, 1997.

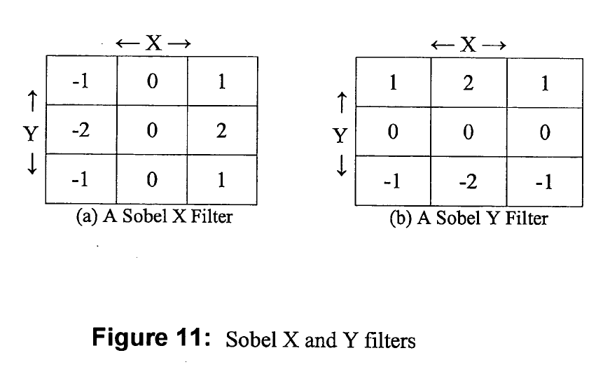

As shown in FIG. 11, a Sobel filter can comprise a set of 3×3 arrays of multiplication factors. A first Sobel filter (left in FIG. 11) is an X filter, to convolute the values of a pixel in the X direction of a color space, such as the RGB space used for the pixel values of an image file 18. As shown in the X filter, the multiplication factors are 0 in the middle column, in the Y direction, where the X value remains the same relative to the central box of the array. Each box surrounding the central box contains a multiplication factor from −2 to +2. A similar array is shown on the right of FIG. 11, to provide a Y filter with the middle row containing multiplication factors of 0, where the Y value remains the same relative to the central box of the array.

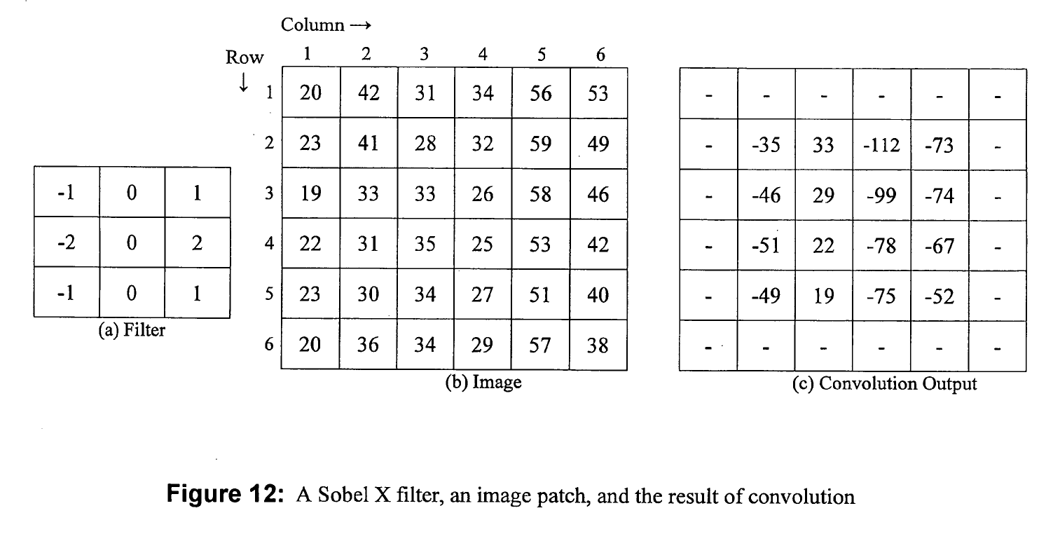

FIG. 12 shows an example of a convolution of image values with a Sobel filter ((a) in FIG. 4) in a gradient generation. For simplification of the description, the example shows convolution of one pixel value, for example, the red value of the RGB values corresponding to each pixel, over a 6×6 row and column pixel array of the image file 18 ((b) in FIG. 12). Moreover, the example shows convolution by an X filter. In a full filtering operation, convolution will occur using both the X filter and the Y filter, applied to each of the red, green and blue components of each pixel value, providing X and Y gradient values for each of the red, green and blue components of each pixel over the full image file 18. The right most array of FIG. 4 (array labeled (c)) shows the convolution output.

In the known process for convolution, the X filter is used as a mask that is inverted and placed over a current pixel, with the central box of the mask over the current pixel. For explanation, refer to the red value of pixel p(2,2) which has a value of 41 in the six row and column example shown in FIG. 12. The red values of the surrounding pixels, clockwise from the upper left: (p(1,1)=20; p(1,2)=42; p(1,3)=31; p(2,3)=28; p(3,3)=33; p(3,2)=33, p(3,1)=19; p(2,1)=23, are each multiplied by the corresponding factor in the inverted filter mask. Thus, 20x1; 42x0; 31x-1; 28x-2; 33x-1; 33x0; 19x1; 23x2. This results in a sum of 20-31-56-33+19+46=−35, as shown in the convolution result for p(2,2).

When the Y value is also calculated in a similar manner, each of the magnitude and direction of the red value change relative to each pixel is determined. The filtering is continued in respect of each of the green and blue components of each pixel, for a full gradient representation of the image. However, both the magnitude and relative magnitude at each pixel location are affected by the illumination conditions at the time the image was recorded.

Pursuant to a feature of the present invention, an illumination invariant gradient is generated form the result of the gradient operation. The original result can be expressed by the formula (relative to the example described above):

R=I_{p(1,1)}−I_{p(1,3)}−2I_{p(2,3)}−I_{p(3,3)}+I_{p(3,1)}+2I_{p(2,1)},

where I_{p(i,j)} represents the image value at the pixel designated by the i and j references, for example, p(1,1).

According to a simple reflection model, each image value for the pixels used to generate the gradient value, as expressed in the above formula for the result R, can be expressed as I_{p(i,j)}=M_{p(i,j)}*L, where M_{p(i,j)} is the material color depicted by the designated pixel and L is the illumination at the pixel at the time the image was recorded. Since the filter covers a relatively small region of the overall image, it is assumed that L is constant over all the pixels covered by the filter mask. It should be understood that each of I_{p(i,j)}, M_{p(i,j)} and L is a vector value with as many elements as there are components in the pixel values, in our example, three elements or color channels corresponding to the RGB space.

Thus, the original gradient result R can be expressed as

R=M_{p(1,1)}*L−M_{p(1,3)}*L−2M_{p(2,3)}*L−M_{p(3,3)}*L+M_{p(3,1)}*L+2M_{p(2,1)}*L.

An illumination invariant gradient result R′ is obtained by normalizing the R value, that is dividing the result R, by the average color of the pixels corresponding to the non-zero values of the filter.

Rζ=M_{p(1,1)}*L−M_{p(1,3)}*L−2M_{p(2,3)}*L−M_{p(3,3)}*L+M_{p(3,1)}*L+2M_{p(2,1)}*L/I_{p(1,1)}+I_{p(1,3)}+I_{p(2,3)}+I_{p(3,3)}+I_{p(3,1)}+I_{p(2,1)}.

Expressing the I_{p(i,j)} values in the above formula for R′ with the corresponding M and L values, as per the equation I_{p(i,j)}=M_{p(i,j)}*L,

R′=M_{p(1,1)}*L−M_{p(1,3)}*L−2M_{p(2,3)}*L−M_{p(3,3)}*L+M_{p(3,1)}*L+2M_{p(2,1)}*L/M_{p(1,1)}*L+M_{p(1,3)}*L+M_{p(2,3)}*L+M_{p(3,3)}*L+M_{p(3,1)}*L+M_{p(2,1)}*L.

In the M and L value expression of the result R′, all of the L values cancel out, leaving an equation for the value of R′ expressed solely in terms of material color values:

R′=M_{p(1,1)}−M_{p(1,3)-}2M_{p(2,3)}−M_{p(3,3)}+M_{p(3,1)}+2M_{p(2,1)}/M_{p(1,1)}+M_{p(1,3)}+M_{p(2,3)}+M_{p(3,3)}+M_{p(3,1)}+M_{p(2,1)}.

Thus, the above equations establish that the value R′ is a fully illumination-invariant gradient measure. However, while the above developed illumination-invariant gradient measure provides pixel values that are the same regardless of illumination conditions, the values still include gradient values caused by shadow edges themselves. The edges of shadows can appear in the same manner as the material edges of objects.

Pursuant to a feature of the present invention, the value R′ is further processed to eliminate gradient values that are caused by shadow edges, to provide gradient values at pixel locations that are derived solely on the basis of material properties of objects. Pixel color values are caused by the interaction between specular and body reflection properties of material objects in, for example, a scene photographed by the digital camera 14 and illumination flux present at the time the photograph was taken. As noted above, the illumination flux comprises an ambient illuminant and an incident illuminant.

According to an aspect of the teachings of the present invention, the spectra of the ambient illuminant and the incident illuminant are different from one another, yet the difference is slight enough such that gradient direction between ambient and incident conditions can be considered to be neutral. Thus, if illumination is changing in a scene, but the material remains the same, the gradient direction between pixels from one measurement to the next should therefore also be neutral. That is, when an edge is due only to illumination change, the two sides of the boundary or edge should have different intensities, but similar colors.

Pursuant to a feature of the present invention, a color change direction, and saturation analysis is implemented to determine if a gradient representation at a particular pixel location is caused by a material change or illumination. Certain conditions, as will be described, indicated by the analysis, provide illumination related characteristics that can identify with a high degree of certainty that a gradient is not caused by illumination, and such identified gradients are retained in the gradient representation. Gradients that do not satisfy the certain conditions, are deleted from the representation, to in effect filter out the gradients likely to have been caused by illumination. The removal of gradients that do not satisfy the certain conditions may remove gradients that are in fact material changes. But a substantial number of material gradients remain in the representation, and, thus, the remaining gradients appear the same regardless of the illumination conditions at the time of recording of the image.

A gradient value at a pixel, the color of the gradient, indicates the amount by which the color is changing at the pixel location. For example, an R′ value for a particular pixel location, in an RGB space, can be indicted by (0.4, 0.9, 0.3). Thus, at the pixel location, the red color band is getting brighter by 0.4, the green by 0.9 and the blue by 0.3. This is the gradient magnitude at the pixel location. The gradient direction can also be determined relative to the particular pixel location. A reference line can extend directly to the right of the pixel location, and rotated counterclockwise, while measuring color change at neighboring pixels, relative to the particular pixel location, to determine the angle of direction in which color change gets maximally brighter. The maximum red color change of 0.4 may occur at, for example 40°, while the maximum green color change occurs at 235°, and the maximum blue color change occurs at 330°.

As noted above, the incident illuminant is light that causes a shadow and is found outside a shadow perimeter, while the ambient illuminant is light present on both the bright and dark sides of a shadow. Thus, a shadow boundary coincides with a diminishing amount of incident illuminant in the direction into the shadow, and a pure shadow boundary (over a single material color) must result in a corresponding lessening of intensity in all color bands, in our example, each of the RGB color channels. Consequently, the gradient directions of all color channels at an illumination boundary, must all be sufficiently similar. Accordingly, pixel locations with substantially different gradient directions among the color channels are considered to be caused by a material change, while pixel locations with sufficiently similar gradient directions may be caused by a either an illumination change or a material change.

Sufficiently similar can be defined in terms of a threshold value. All color channels must have a direction within the threshold of one another. Thus, for example, the direction of the red color channel must be within the threshold value relative to the direction of the green color. A convenient threshold is 90°, because in accordance with known properties of linear algebra, when a dot product between two vectors is positive, the two vectors are within 90° of one another. Conversely, when the dot product between two vectors is negative, the two vectors are not within 90° of one another. Each gradient direction can be expressed as a vector, and the dot products easily determined to verify similarity of direction.

In our example, the gradient directions for the red, green and blue components vary from 45°, to 235°, to 330°. Thus, the pixel under examination is due to a material change since, for example, the color red is increasing maximally in the direction of 45°, 170° away from the 235° direction of the color green, while the 235° direction is 95° away from the 330° direction of the color blue. All such pixel locations are kept in the gradient representation, while all pixel locations having color channels with sufficiently similar gradient directions (within 90° of one another) are subject to a test for color saturation, to determine if the gradient is due to a material change or an illumination change.

A gradient value is essentially a measure of color differences among pixel locations. In the exemplary embodiment utilizing a Sobel filter, the gradient value is a subtraction of two colors averaged over a small area of the image (in our example, a 3×3 array). In the case of a gradient caused by different illumination over the same material (the type of gradient to be filtered out of the gradient representation of an image according to a feature of the present invention), the gradient measurement can be expressed by the equation: (M*L₁−M*L₂)/(M*L₁+M*L₂)=(L₁−L₂)/(L₁+L₂). The gradient measure of the equation represents the spectral difference of the two light values L₁ and L₂ when the gradient corresponds to a simple illumination change over a single material. In such a case, the magnitudes of the gradient in each color channel should be substantially equal, and thus neutral. A determination of the saturation of the gradient color corresponding to a pixel location showing sufficiently similar gradient directions can be used to measure how neutral or non-neutral the respective color is at the pixel location.

Saturation can be measured by any known technique, such as, for example, the relationship of (max−min)/max. A saturation determination for a gradient at a particular pixel location can be compared to a threshold value. If the color saturation at a particular pixel location showing sufficiently similar gradient directions, is more saturated than the threshold value, the pixel location is considered a gradient representation based upon a material change. If it is the same as or less than the saturation of the threshold value, the particular pixel location showing sufficiently similar gradient directions is considered a gradient representation based upon an illumination change, and removed from the gradient representation for the image. The threshold value can be based upon an empirical or experimentally measured saturation of an illumination relevant to the illumination conditions expected to be incurred during the recording of images. For example, when the images are to be recorded outdoors during daylight hours, (L₁−L₂)/(L₁+L₂) values can correspond to sunlight and skylight near sunset, respectively. Such values represent a maximal difference in spectra likely to be expected in natural illumination.

Upon completion of tests for similarity of gradient direction and color saturation, all gradient values representing illumination boundaries have been filtered out, and the remaining gradient representations, according to a feature of the present invention, include only gradient values corresponding to material change. As noted above, the removal of gradients that show both a similarity of direction and neutral saturation may remove some gradients that are in fact material changes. However, the material gradients that are removed are always removed, irrespective of illumination conditions, and a substantial number of material gradients remain in the representation, with the remaining gradients appearing the same regardless of the illumination conditions at the time of recording of the image.

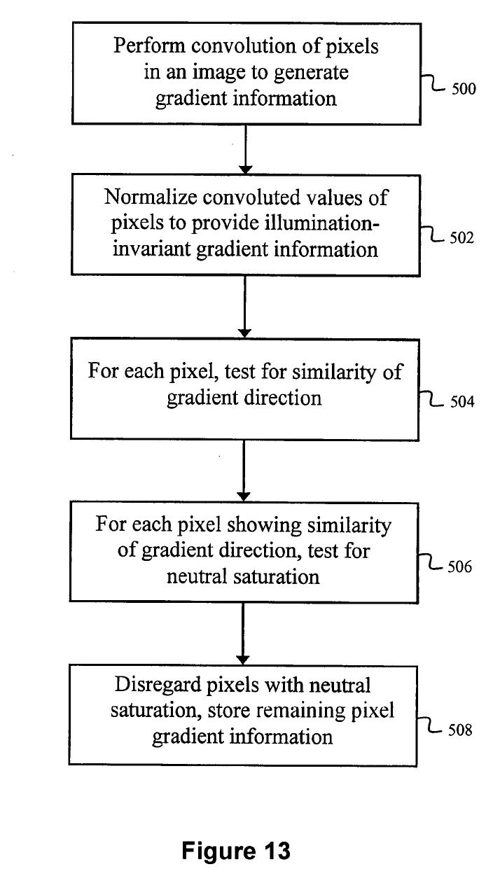

Referring now to FIG. 13 there is shown a flow chart for generating a gradient representation of an image that solely reflects material aspects, such as object edges, according to a feature of the present invention. In step 500, the CPU 12a performs a convolution of pixel values, for example using a Sobel filter, as described above, in a subject image of an image file 18 depicting a high dynamic range, linear high quality image output by the CPU 12a through execution of steps 110-110 (FIG. 3), to generate gradient information for the image. In step 502, the CPU 12 normalizes the gradient information to provide illumination-invariant gradient information. The normalizing operation can be implemented by dividing the Sobel filter result, by the average color of the pixels corresponding to the non-zero values of the Sobel filter.

In step 504, at each pixel location in the image file 18, the CPU 12a tests the gradient information for similarity of direction in each color channel, for example RGB color channels. In step 506, the CPU 12a further tests all pixel locations showing sufficiently similar gradient directions, for neutral saturation. In step 508, the CPU 12a disregards pixel locations with neutral saturation and stores the remaining pixel gradient information to provide an illumination-invariant gradient representation of the image file 18, with all gradient information corresponding to material aspects of the image. In the described exemplary embodiment, Sobel filters were used to generate the gradient information. However, any known method for generating gradient information, such as Difference of Gaussians, can be implemented.

The output of step 112 (FIG. 3a) is therefore a high dynamic range, linear high quality image, with a corresponding illumination-invariant gradient representation, object depth information and an indication of illumination and material aspects of the image, for example, pixel lit and shadow conditions, for optimized computer analysis of the recorded scene.

In step 114, the CPU 12a is operated further to perform a spatio-spectral analysis on the image input from step 112. For example, as noted, pixel values of an image file 18, from both sides of a boundary, are sampled at, for example, three intensities or color bands, in long, medium and short wave lengths such as red, green and blue. A spectral ratio, as defined above, is calculated from the sampled color values. If the spectral ratio associated with the boundary is approximately equal to the characteristic spectral ratio determined for the scene, as described above, the boundary would be classified as an illumination boundary. In this manner, illumination boundaries of a scene depicted in an image file 18 can be identified and marked in an illumination map corresponding to the image. Moreover, spectral relationships among contiguous pixels, in terms of color bands, for example the RGB values of the pixels, and the spatial extent of the pixel spectral characteristics relevant to a single material can be analyzed by the CPU 12a to identify regions of the image corresponding to a single material.

The output of step 114 (FIG. 3a) therefore further enhances the high dynamic range, linear high quality image, and corresponding illumination-invariant gradient representation, object depth information and indication of illumination and material aspects of the image, for example, pixel lit and shadow conditions, with material and illumination information for the scene depicted in the image.

In the preceding specification, the reference numerals refer to FIG. 1a, unless the camera 14a is not equipped with the described functionality, then the performance of image processing is completed by the CPU 12b. Moreover, the invention has been described with reference to specific exemplary embodiments and examples thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

What is claimed is:

1. An optical device comprising:
a lens;
an image sensor coupled to the lens, to generate images of a scene; and
a CPU coupled to the image sensor;
the CPU arranged and configured to execute a routine to receive the images and create a high dynamic range version of the images for spatio-spectral analysis.

2. The optical device of claim 1 wherein the optical device comprises a digital camera.

3. The optical device of claim 1 wherein the optical device comprises a pair of digital cameras arranged and configured to generate stereo pairs of images of the scene for object depth analysis.

4. The optical device of claim 1 wherein the optical device is operated to generate images of the scene at preselected varying exposures for determining a dynamic range for color values of the high dynamic range version of the images.

4. An optical device comprising:
a lens;
an image sensor coupled to the lens, to generate images of a scene; and
a CPU coupled to the image sensor;
the CPU arranged and configured to execute a routine to receive the images, correct chromatic aberration in the images and create a high dynamic range version of the images for spatio-spectral analysis.

5. An optical device comprising:
a lens;
a variable polarizer attached to the lens;
an image sensor coupled to the lens, to generate images of a scene at preselected varying polarizer orientations;
a CPU coupled to the image sensor;
the CPU arranged and configured to execute a routine to receive the images, and identify lit and shadow conditions as a function of polarizer orientation and to perform preselected preprocessing of the images to create a version of the images optimized for spatio-spectral analysis.

6. An optical device comprising:
a lens;
an image sensor coupled to the lens, to generate images of a scene; and
a CPU coupled to the image sensor;
the CPU arranged and configured to execute a routine to receive the images and perform preselected preprocessing of the images to create a version of the images optimized for spatio-spectral analysis.

7. The optical device of claim 6 wherein the preselected preprocessing is selected from the group consisting of linearization, chromatic aberration correction, and high dynamic range image creation.

8. The optical device of claim 7 wherein the optical device comprises a camera.

9. The optical device of claim 7 wherein the optical device comprises a pair of cameras arranged and configured to generate stereo pairs of images of the scene for object depth analysis.

10. The optical device of claim 7 wherein the optical device comprises a camera and a range sensor.

11. The optical device of claim 7 wherein the CPU is further arranged and configured to generate an illumination-invariant gradient representation corresponding to the version of the images optimized for spatio-spectral analysis.

12. An optical device comprising:
a lens;
an image sensor coupled to the lens, to generate images of a scene, the image sensor capturing the images in a preselected number of color bands, with the number and respective locations and widths of the color bands being selected to optimize the image for processing; and
a CPU coupled to the image sensor;
the CPU arranged and configured to execute a routine to receive the images and perform preselected preprocessing of the images to create a version of the images optimized for spatio-spectral analysis.

13. The optical device of claim 12 wherein the preselected preprocessing is selected from the group consisting of linearization, chromatic aberration correction, and high dynamic range image creation.

14. The optical device of claim 13 wherein the optical device comprises a camera.

15. The optical device of claim 13 wherein the optical device comprises a pair of cameras arranged and configured to generate stereo pairs of images of the scene for object depth analysis.

16. The optical device of claim 13 wherein the optical device comprises a camera and a range sensor.

17. An optical device comprising:
a lens;
an image sensor coupled to the lens, to generate images of a scene; and
a CPU coupled to the image sensor;
the CPU arranged and configured to execute a routine to receive the images and perform preselected preprocessing and spatio-spectral analysis of the images to create a version of the images optimized for analysis of the scene.

18. The optical device of claim 17 wherein the preselected preprocessing is selected from the group consisting of linearization, chromatic aberration correction, and high dynamic range image creation.

19. The optical device of claim 17 wherein the spatio-spectral analysis includes material and illumination information for the scene.

20. The optical device of claim 19 wherein the material and illumination information comprises spectral ratio analysis.

21. An optical device comprising:
a lens;
an image sensor coupled to the lens, to generate images of a scene; and
a CPU coupled to the image sensor;
the CPU arranged and configured to execute a routine to receive the images and perform preselected spatio-spectral analysis of the images to create a version of the images optimized for analysis of the scene.

22. The optical device of claim 21 wherein the spatio-spectral analysis includes material and illumination information for the scene.

23. The optical device of claim 22 wherein the material and illumination information comprises spectral ratio analysis.

24. An image processor, comprising:
a CPU arranged and configured to receive an image input, the image input depicting a scene;
the CPU being further arranged and configured to execute a routine to receive the image input and perform preselected spatio-spectral analysis of the image to create a version of the image input optimized for analysis of the scene.

25. The image processor of claim 24 wherein the spatio-spectral analysis includes material and illumination information for the scene.

26. The image processor of claim 25 wherein the material and illumination information comprises spectral ratio analysis.

27. An image processor, comprising:
a CPU arranged and configured to receive an image input, the image input depicting a scene;
the CPU being further arranged and configured to execute a routine to receive the image input and perform preselected preprocessing and spatio-spectral analysis of the image to create a version of the image input optimized for analysis of the scene.

28. The image processor of claim 27 wherein the preselected preprocessing is selected from the group consisting of linearization, chromatic aberration correction, and high dynamic range image creation.

29. The image processor of claim 27 wherein the spatio-spectral analysis includes material and illumination information for the scene.

30. The image processor of claim 29 wherein the material and illumination information comprises spectral ratio analysis.
